(19) United States
(12) Patent Application Publication
(10) Pub. No.: US 2025/0219432 A1
(43) Pub. Date: Jul. 3, 2025

(54) SWITCHING CIRCUIT, POWER RECEIVING DEVICE USING THE SAME AND MODE SWITCHING METHOD THEREOF

(71) Applicant: LITE-ON TECHNOLOGY CORPORATION, Taipei (TW)

(72) Inventor: Jin-Jye CHOU, Taipei (TW)

(21) Appl. No.: 18/594,027

(22) Filed: Mar. 4, 2024

(30) Foreign Application Priority Data
Dec. 29, 2023 (CN) 202311845202.1

(51) Int. Cl. H02J 7/00

(52) U.S. Cl. CPC H02J 7/00712; H02J 7/00045; H02J 7/0042; H02J 2207/20

(57) ABSTRACT

A switching circuit is disposed on a power receiving device and is electrically connected to a Universal Serial Bus Type-C (USB Type-C) connector of the power receiving device. The switching circuit includes a determination module, a PD controller, and a mode switching module. The determination module is configured to: determine whether a power supply device supports a power delivery (PD) mode according to a pin signal of a configuration channel (CC) pin of the USB Type-C connector; and generate a first switching signal based on the fact that the power supply device does not support the PD mode. The PD controller is electrically connected to the pin signal determination module. The mode switching module is selectively electrically connected to the PD controller and configured to be disconnected from the PD controller based on the first switching signal.

This application claims the benefit of People's Republic of China application Serial No. 202311845202.1, filed on Dec. 29, 2023, the subject matter of which is incorporated herein by reference.

### BACKGROUND OF THE INVENTION

### Field of the Invention

The invention relates in general to a switching circuit, a power receiving device using the same and a mode switching method thereof.

### Description of the Related Art

USB-PD is a power transmission specification defined by the USB-IF Association. After communication with the system is completed through the USB Type-C connector, a charging may begin. However, when the power supply device is connected to the power receiving device, if the power supply device does not support a power delivery (PD) mode, a PD mode protocol will not be performed, and thus the power receiving device keeps waiting for the signal from the power supply device. As a result, the power receiving device and the power supply device can't successfully complete the power agreement, resulting in the inability to perform subsequent charging and data transmission.

### SUMMARY OF THE INVENTION

The present invention relates to a switching circuit, a power receiving device using the same and a mode switching method thereof capable of resolving existing problems disclosed above.

According to one embodiment of the present invention, a switching circuit is provided. The switching circuit is disposed on a power receiving device and electrically connected to a Universal Serial Bus Type-C (USB Type-C) connector of the power receiving device, and includes a determination module, a PD controller and a mode switching module. The determination module is configured to determine whether a power supply device supports a power delivery (PD) mode according to a pin signal of a Configuration Channel (CC) pin of the USB Type-C connector; and generate a first switching signal based on the power supply device not supporting the PD mode. The PD controller is electrically connected to the determination module. The mode switching module is selectively electrically connected to the PD controller and configured to be disconnected from the PD controller according to the first switching signal.

According to another embodiment of the present invention, a power receiving device is provided. The power receiving device includes a USB Type-C connector and a switching circuit. The switching circuit is electrically connected to the USB Type-C connector and includes a determination module, a PD controller and a mode switching module. The determination module is configured to determine whether a power supply device supports a power delivery (PD) mode according to a pin signal of a Configuration Channel (CC) pin of the USB Type-C connector; and generate a first switching signal based on the power supply device not supporting the PD mode. The PD controller is electrically connected to the determination module. The mode switching module is selectively electrically connected to the PD controller and configured to be disconnected from the PD controller according to the first switching signal.

According to an alternate embodiment of the present invention, a mode switching method is provided. The mode switching method includes the following steps: determining whether a power supply device supports a PD mode according to a pin signal of a CC pin of a USB Type-C connector of a power receiving device by a determination module; generating a first switching signal based on the power supply device not supporting the PD mode by the determination module; and disconnecting a mode switching module from a PD controller of the power receiving device based on the first switching signal.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 illustrates a functional block diagram of the power receiving device of an electronic system in the PD mode according to an embodiment of the present invention;

FIG. 2 illustrates a functional block diagram of the power receiving device of FIG. 1 in non-PD mode;

FIG. 3A illustrates a schematic diagram of an electronic system according to a first embodiment of the present invention;

FIG. 3B illustrates a schematic diagram of an electronic system according to a second embodiment of the present invention;

FIG. 3C illustrates a schematic diagram of an electronic system according to a third embodiment of the present invention;

FIG. 4A illustrates a schematic diagram of the conversion signal obtained corresponding to the first embodiment of FIG. 3A;

FIG. 4B illustrates a schematic diagram of the conversion signal obtained corresponding to the second embodiment of FIG. 3B;

FIG. 4C illustrates a schematic diagram of the conversion signal obtained corresponding to the third embodiment of FIG. 3C;

FIG. 5 illustrates a circuit diagram of the detection unit in FIG. 1;

FIG. 6 illustrates a functional block diagram of the signal generation unit in FIG. 1;

FIG. 7 illustrates a flow chart of a mode switching method of the power receiving device in FIG. 1; and

FIG. 8 illustrates a flow chart of another mode switching method of the power receiving device in FIG. 1.

### DETAILED DESCRIPTION OF THE INVENTION

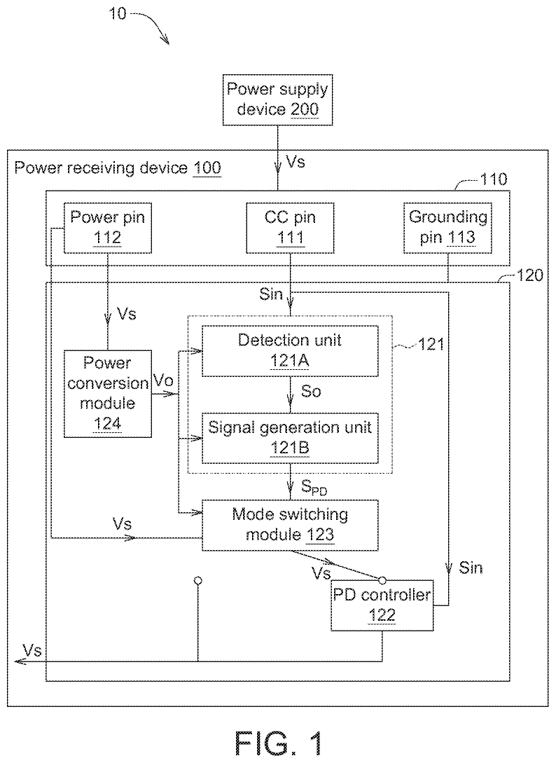

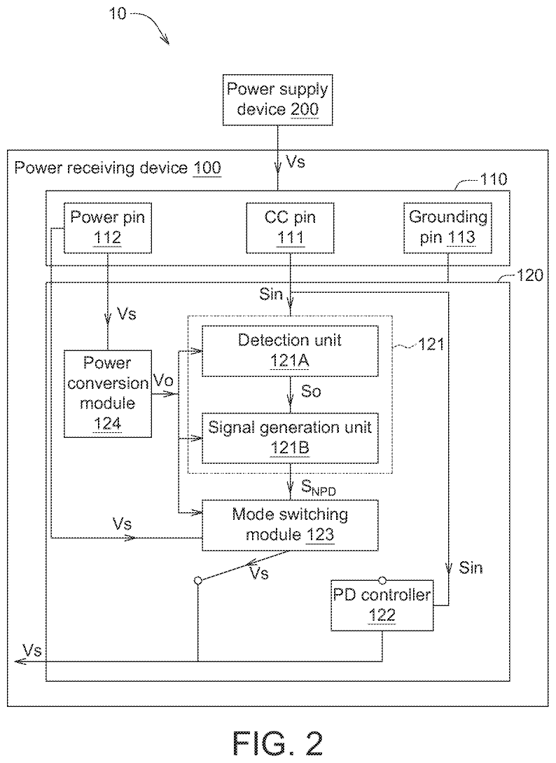

Referring to FIGS. 1 to 2, FIG. 1 illustrates a functional block diagram of the power receiving device 100 of an electronic system 10 in the PD mode according to an embodiment of the present invention, and FIG. 2 illustrates is a functional block diagram of the power receiving device 100 of FIG. 1 in non-PD mode.

As illustrated in FIG. 1, the electronic system 10 includes the power receiving device 100 and the power supply device 200. The power receiving device herein is, for example, a notebook computer, a smart phone, a tablet, an embedded network communication product, and other electronic devices that may receive power supply. The power receiving device may be applied to a mobile personal equipment, or various personal or non-personal electronic product. The power supply device herein is an electronic device, for example, a mobile power supply or an AC to DC non-mobile power supply, that may provide power (voltage and/or current).

As illustrated in FIGS. 1 and 2, the power receiving device 100 includes a Universal Serial Bus Type-C (USB Type-C) connector 110 and a switching circuit 120. The switching circuit 120 and the USB Type-C connector 110 may, for example, be disposed on a circuit board (not illustrated) of the power receiving device 100. The USB Type-C connector 110 is exposed from a casing (not illustrated) of the power receiving device 100 for being connected with the power supply device 200. The USB Type-C connector 110 at least includes a CC (Configuration Channel) pin 111, a power pin 112 and a grounding pin 113, wherein the power pin 112 may accept an input power V_{S} of the power supply device 200, and the grounding pin 111 may be electrically connected to a grounding potential (not illustrated).

As illustrated in FIGS. 1 and 2, the switching circuit 120 includes a determination module 121, a PD controller 122, a mode switching module 123 and a power conversion module 124. The determination module 121, the PD controller 122, the mode switching module 123 and/or the power conversion module 124 are physical circuits, for example, a semiconductor chip or a semiconductor package which are formed by using at least one semiconductor process. In an embodiment, at least two of the determination module 121, the mode switching module 123, the PD controller 122 and the power conversion module 124 may be integrated into one single module. In another embodiment, at least one of the determination module 121, the PD controller 122, the mode switching module 123 and the power conversion module 124 may be integrated into a processor (not illustrated) or a controller (not illustrated).

As illustrated in FIGS. 1 and 2, the determination module 121 is configured to determine whether the power supply device 200 supports the PD mode according to a pin signal Sᵢₙ of the CC pin 111 of the USB Type-C connector 110; generate a first switching signal SNPD (the first switching signal SNPD is illustrated in FIG. 2) based on the power supply device 200 not supporting the PD mode. The PD controller 122 is electrically connected to the determination module 121. The mode switching module 123 is selectively electrically connected to the PD controller 122 and configured to be disconnected from the PD controller 122 (as illustrated in FIG. 2) according to the first switching signal SNPD. As a result, when the power supply device 200 does not support the PD mode, the power receiving device 100 automatically switches to the non-PD mode, so that the power receiving device 100 and the power supply device 200 may perform subsequent charging and/or data transmission.

The aforementioned first switching signal SNPD is, for example, a non-PD mode switching signal, and a second switching signal SPD is, for example, a PD mode switching signal.

In an embodiment, the power receiving device 100 may be preset to the PD mode. As a result, when the power supply device 200 supports the PD mode, the power receiving device 100 and the power supply device 200 may directly perform the PD protocol without the control signal of the determine module 121. Furthermore, as illustrated in FIG. 1, when the power supply device 200 is connected to the power receiving device 100, the mode switching module 123 may directly conduct the PD controller without the control signal of the determine module 121. As a result, when the power supply device 200 supports the PD mode, the PD controller 122 of the power receiving device 100 may perform the PD protocol with the power supply device 200 according to the pin signal Sᵢₙ. After completing the PD protocol, the power receiving device 100 and the power supply device 200 may perform subsequent charging and/or data transmission.

The power conversion module 124 electrically connects the power pin 112 with the determination module 121. The power conversion module 124 may convert the input power V_{S} provided by the power supply device 200 into a working power V_{O}. The working power supply V_{O} is different from the input power V_{S}. For example, the working power supply V_{O} is less than the input power V_{S}. The working power V_{O} may be provided to an electronic component (not illustrated) for operation, such as a detection unit 121A, a signal generation unit 121B, the PD controller 122, the mode switching module 123 and/or other component, which is disposed inside the power receiving device 100. In another embodiment, the power conversion module 124 may convert the input power V_{S} provided by the power supply device 200 into a plurality of working power with different voltages, and provide them to different components (for example, the detection unit 121A, the signal generation unit 121B, the PD controller 122, the mode switching module 123 and/or other component).

In addition, as illustrated in FIG. 1, in the PD mode, the input power V_{S} provided by the power supply device 200 may be provided to other internal component of the power receiving device 100 for the operation through the power pin 112, the mode switching module 123 and the PD controller 122. As illustrated in FIG. 2, in the non-PD mode, the input power V_{S} provided by the power supply device 200 may be provided to other internal component of the power receiving device 100 through the power pin 112 and the mode switching module 123.

As illustrated in FIG. 1, the determination module 121 includes the detection unit 121A and the signal generation unit 121B. The detection unit 121A may convert the pin signal Sᵢₙ into a conversion signal S_{O}. The signal generation unit 121B is configured to determine whether the power supply device 200 supports the PD mode according to the conversion signal S_{O}; generate the first switching signal SNPD (the first switching signal SNPD is illustrated in FIG. 2) based on the power supply device 200 not supporting the PD mode; and/or generate the second switching signal SPD (the second switching signal SPD is illustrated in FIG. 1) based on the power supply device 200 supporting the PD mode.

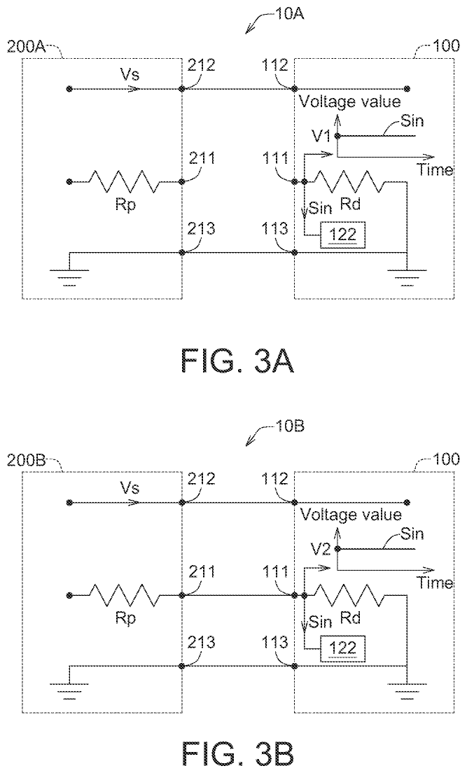

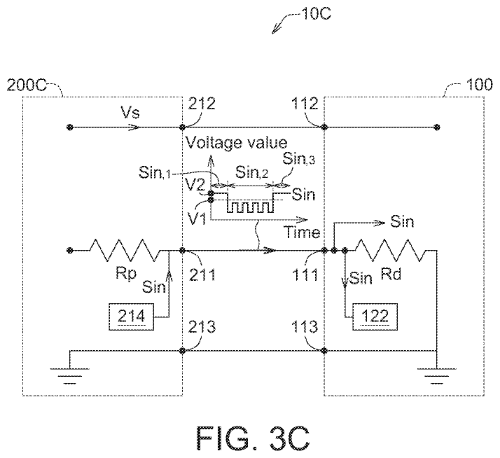

Referring to FIGS. 3A to 4C, FIG. 3A illustrates a schematic diagram of an electronic system 10A according to a first embodiment of the present invention, FIG. 3B illustrates a schematic diagram of an electronic system 10B according to a second embodiment of the present invention, FIG. 3C illustrates a schematic diagram of an electronic system 10C according to a third embodiment of the present invention, FIG. 4A illustrates a schematic diagram of the conversion signal S_{O} obtained corresponding to the first embodiment of FIG. 3A, FIG. 4B illustrates a schematic diagram of the conversion signal S_{O} obtained corresponding to the second embodiment of FIG. 3B, and FIG. 4C illustrates a schematic diagram of the conversion signal S_{O} obtained corresponding to the third embodiment of FIG. 3C.

In the first embodiment, as illustrated in FIG. 3A, the electronic system 10A includes a power supply device 200A and a power receiving device 100 connected with power supply device 200A. The power supply device 200A at least includes a connector, such as USB-Type A, USB-Type C or other type. The connector includes a pin 211, a power pin 212 and a grounding pin 213. The pin 211 is electrically connected to a resistor Rₚ. The CC pin 111 of the power receiving device 100 is electrically connected to the resistor R_{d}. The embodiment of the present invention does not limit the values of the resistor Rₚ and the resistor R_{d}. For example, the power supply device 200A does not support the PD mode and its pin 211 does not provide a connection function. That is, when the power supply device 200A is connected with the power receiving device 100, there is no electrical signal transmission between the pin 211 of the power supply device 200A and the CC pin 111 of the power receiving device 100. The input power V_{S} may be provided to the power pin 112 of the power receiving device 100 through the power pin 212 of the power supply device 200A.

In the first embodiment, as illustrated in FIG. 3A, when the power supply device 200A is connected with the power receiving device 100, based on the circuit at least composed of the CC pin 111 and the resistor R_{d}, the pin signal Sᵢₙ has the first voltage V₁, the first voltage V₁ is, for example, 1.1 volt (V), less or greater. The pin signal Sᵢₙ is, for example, a node signal between the CC pin 111 and the resistor R_{d}.

In the first embodiment, as illustrated in FIG. 4A, when the power supply device 200A is connected with the power receiving device 100, based on the pin signal Sᵢₙ having the first voltage V₁, the detection unit 121A of the power receiving device 100 converts the pin signal Sᵢₙ into a corresponding conversion signal S_{O}, where the conversion signal S_{O} has, for example, a first conversion voltage Vₜₕ₁. In the present embodiment, the first conversion voltage Vₜₕ₁ is, for example, a constant. In other words, the first conversion voltage Vₜₕ₁ in FIG. 4A is horizontal and its value does not change. The first conversion voltage Vₜₕ₁ is 0, for example. The signal generation unit 121B outputs the first switching signal SNPD according to the first conversion voltage Vₜₕ₁.

In the second embodiment, as illustrated in FIG. 3B, the electronic system 10B includes a power supply device 200B and a power receiving device 100 connected with the power supply device 200B. The power supply device 200B at least includes the pin 211, the power pin 212 and the grounding pin 213. For example, the power supply device 200B does not support PD mode and its pin 211 provides the connection function. That is, when the power supply device 200B is connected with the power receiving device 100, there is the electrical signal transmission between the pin 211 of the power supply device 200B and the CC pin 111 of the power receiving device 100. The input power V_{S} may be provided to the power pin 112 of the power receiving device 100 through the power pin 212 of the power supply device 200B.

In the second embodiment, as illustrated in FIG. 3B, when the power supply device 200B is connected with the power receiving device 100, based on the circuit at least composed of the CC pin 111, the pin 211, the resistor Rₚ and the resistor R_{d}, the pin signal Sᵢₙ has, for example, the second voltage V₂. The second voltage V₂ is, for example, 1.6 V, less or greater. The pin signal Sᵢₙ is, for example, a node signal between the CC pin 111 and the resistor R_{d}.

In the second embodiment, as illustrated in FIG. 4B, when the power supply device 200A is connected with the power receiving device 100, based on the pin signal Sᵢₙ having the second voltage V₂, the detection unit 121A of the power receiving device 100 converts the pin signal Sᵢₙ into a corresponding conversion signal S_{O}, wherein the conversion signal S_{O} has a second conversion voltage Vₜₕ₂. The second conversion voltage Vₜₕ₂ is different from the first conversion voltage Vₜₕ₁, and the second conversion voltage Vₜₕ₂ is, for example, 3.3 V.

In the third embodiment, as illustrated in FIG. 3C, the electronic system 10C includes a power supply device 200C and a power receiving device 100 connected with the power supply device 200C. The power supply device 200C at least includes the pin 211, the power pin 212, the grounding pin 213 and the PD controller 214. For example, the power supply device 200C supports the PD mode and its pin 211 provides the connection function. That is, when the power supply device 200B is connected with the power receiving device 100, there is the electrical signal transmission between the pin 211 of the power supply device 200B and the CC pin 111 of the power receiving device 100. The input power V_{S} may be provided to the power pin 112 of the power receiving device 100 through the power pin 212 of the power supply device 200C.

In the third embodiment, as illustrated in FIG. 3C, when the power supply device 200C is connected with the power receiving device 100, the PD controller 214 may provide the pin signal Sᵢₙ to the pin 211. In other words, the pin signal Sᵢₙ in the present embodiment is a signal generated by the PD controller 214. The pin signal Sᵢₙ is, for example, a Biphase Mark Coding (BMC) signal. The BMC signal has a first region S_{in,1}, a coding region S_{in,2} and a second region S_{in,3}. The level of the coding region S_{in,2} is lower than the first region S_{in,1} and the second region S_{in,3}. In an embodiment, the level of the first region S_{in,1} and the level of the second region S_{in,3} are, for example, the second voltage V₂ (for example, 1.6 V), and the level of the encoding region S_{in,2} is not higher than or lower than the first voltage V₁ (e.g., 1.1 V). The pin signal Sᵢₙ may be transmitted to the PD controller 122 and the switching circuit 120 of the power receiving device 100 through the pin 211 of the power supply device 200C and the CC pin 111 of the power receiving device 100 (not illustrated in FIG. 3C). The PD controller 214 and the PD controller 122 may perform power protocol through the BMC signal.

In the third embodiment, as illustrated in FIG. 4C, when the power supply device 200C is connected with the power receiving device 100, based on the pin signal Sᵢₙ being the BMC signal, the detection unit 121A of the power receiving device 100 converts the pin signal Sᵢₙ into a corresponding conversion signal S_{O}, wherein the conversion signal S_{O} has at least one waveform change region (for example, a square wave). For example, the conversion signal S_{O} in FIG. 4C includes a first conversion region S_{O,1}, a waveform change region S_{O,2} and a second conversion region S_{O,3}. The pin signal Sᵢₙ includes the first region S_{in,1}, the coding region S_{in,2} and the second region S_{in,3}. As illustrated in FIGS. 3C and 4C, the level of the first region S_{in,1} is the second voltage V₂ (for example, 1.6 V), which is higher than the second threshold value (for example, 1.55 V), so the first conversion region S_{O,1} of the corresponding conversion signal S_{O} is the second conversion voltage Vₜₕ₂ (for example, 3.3 V). The level of the coding region S_{in,2} is not higher than the first voltage V₁ (for example, 1.1 V), which is lower than the first threshold value (for example, 1.25 V), so the waveform change region S_{O,2} of the corresponding conversion signal S_{O} is the first conversion voltage Vₜₕ₁ (for example, 0 V). The level of the second region S_{in,3} is the second voltage V₂ (for example, 1.6 V), which is higher than the second threshold value (for example, 1.55 V). Thus, the second conversion region S_{O,3} of the corresponding conversion signal S_{O} is the second conversion voltage Vₜₕ₂ (for example, 3.3 V).

The detection unit 121A may convert the pin signal Sᵢₙ into the conversion signal S_{O} by using, for example, Schmitter Trigger technology. Further examples are given below.

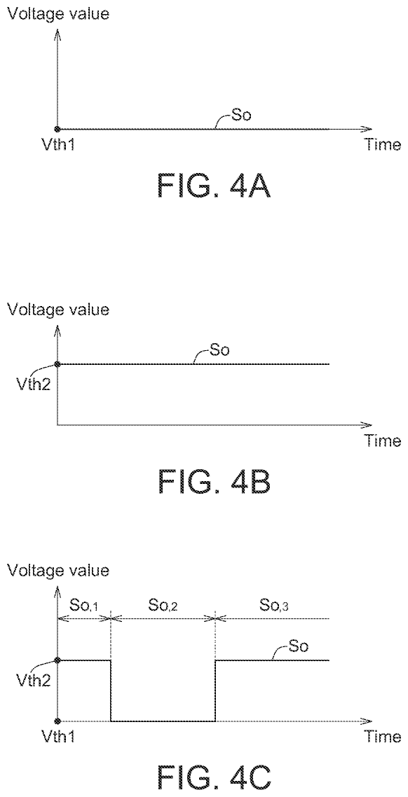

Referring to FIG. 5, FIG. 5 illustrates a circuit diagram of the detection unit 121A in FIG. 1. The detection unit 121A includes, for example, a detection circuit which includes, for example, a comparator 121A1, a resistor R1, a resistor R2, and a resistor R3. The pin signal Sᵢₙ may be input to an input terminal of the comparator 121A1, and a reference voltage V_{CC} may be input to a reference terminal of the comparator 121A1. The detection circuit at least composed of the comparator 121A1, the resistor R1, the resistor R2 and the resistor R3 may output the corresponding conversion signal S_{O} according to the input pin signal Sᵢₙ. For example, when the input pin signal Sᵢₙ is lower than the first threshold value, the detection circuit may output the conversion signal S_{O} with the first conversion voltage Vₜₕ₁; when the input pin signal Sᵢₙ is higher than the second threshold value, the detection circuit may output the conversion signal S_{O} with the second conversion voltage Vₜₕ₂.

In the case of the resistor R1 being 39.2 kΩ, the resistor R2 being 28 kΩ, the resistor R3 being 162 kΩ, and the reference voltage V_{CC} being 3.3 V, the first threshold value is 1.25 V, and the second threshold value is 1.55 V. As a result, when the input pin signal Sᵢₙ is lower than 1.25 V (first threshold value), the output conversion signal S_{O} is 0 V (the first conversion voltage Vₜₕ₁); when the input pin signal Sᵢₙ is higher than 1.55 V (the second threshold value), the output conversion signal S_{O} is 3.3 V (the second conversion voltage Vₜₕ₂).

Taking the first embodiment as an example, as illustrated in FIG. 3A, due to the input pin signal Sᵢₙ having the first voltage V₁, which is 1.1 V lower than 1.25 V, the output conversion signal S_{O} is 0 V (the first conversion voltage Vₜₕ₁ in FIG. 4A).

Taking the second embodiment as an example, as illustrated in FIG. 3B, due to the input pin signal Sᵢₙ having the second voltage V₂, which is 1.6 V higher than 1.55 V, the output conversion signal S_{O} is 3.3 V (the second conversion voltage Vₜₕ₂ in FIG. 4B).

Taking the third embodiment as an example, as illustrated in FIG. 3C, the input pin signal Sᵢₙ is the BMC signal, and the corresponding conversion signal S_{O} has at least one waveform change region S_{O,2}, as illustrated in FIG. 4C. For example, the conversion signal S_{O} includes the first conversion region S_{O,1}, the waveform change region S_{O,2} and the second conversion region S_{O,3}. Due to the level of the first region S_{in,1} being 1.6 V which is higher than 1.55 V (the second threshold value), the corresponding first conversion region S_{O,1} of the conversion signal S_{O} is 3.3 V (the second conversion voltage Vₜₕ₂). The level of the encoding region S_{in,2} is not higher than 1.1 V, which is lower than 1.25 V (the first threshold value), so the waveform change region S_{O,2} of the corresponding conversion signal S_{O} is OV (the first conversion voltage Vₜₕ₁). The level of the second region S_{in,3} is 1.6 V, which is higher than 1.55 V (the second threshold value), so the second conversion region S_{O,3} of the corresponding conversion signal S_{O} is 3.3 V (the second conversion voltage Vₜₕ₂).

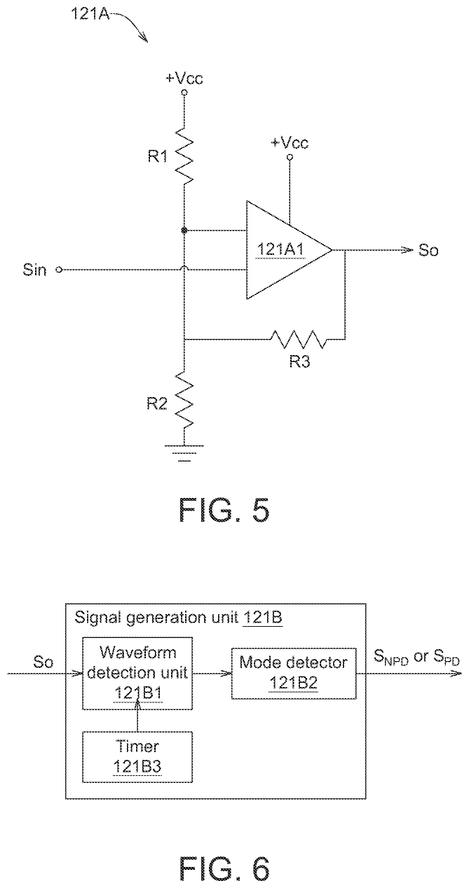

Referring to FIG. 6, FIG. 6 illustrates a functional block diagram of the signal generation unit 121B in FIG. 1. The signal generation unit 121B includes a waveform detection unit 121B1, a mode detector 121B2 and a timer 121B3. The waveform detection unit 121B1 is configured to detect whether the conversion signal S_{O} changes. The aforementioned “change” is, for example, “the conversion signal S_{O} has a waveform change region.” The mode detector 121B2 is configured to generate the second switching signal SPD based on the change in the conversion signal S_{O}; and generate the first switching signal SNPD based on absence of change in the conversion signal S_{O}. In an embodiment, the first switching signal SNPD is, for example, one of 0 and 1, and the second switching signal SPD is, for example, the other one of 0 and 1.

As illustrated in FIG. 6, in an embodiment, the waveform detection unit 121B1 detects whether the conversion signal S_{O} changes within a detection time interval (for example, several seconds). For example, the timer 121B3 may provide a timing to the waveform detection unit 121B1. The waveform detection unit 121B1 may detect whether the conversion signal S_{O} changes within the detection time interval according to the timing of the timer 121B3. During the detection time interval, if the detection conversion signal S_{O} does not change, the mode detector 121B2 generates the first switching signal SNPD; if the detection conversion signal S_{O} changes, the mode detector 121B2 generates the second switching signal SPD.

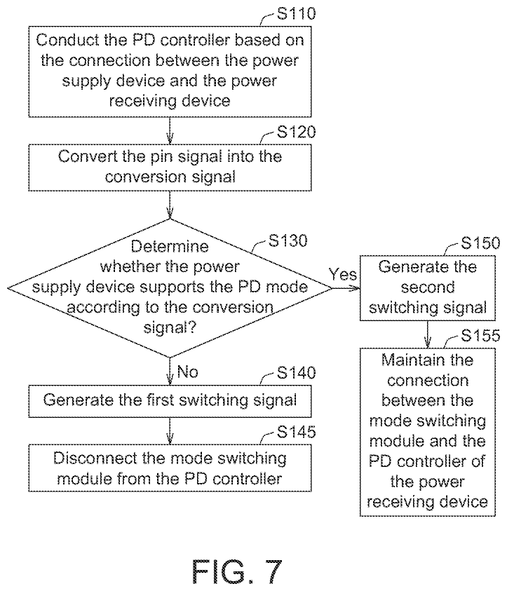

Referring to FIG. 7, FIG. 7 illustrates a flow chart of a mode switching method of the power receiving device 100 in FIG. 1.

In step S110, based on the connection between the power supply device 200 and the power receiving device 100, the mode switching module 123 conducts the PD controller 122. In other words, when the power supply device 200 is connected with the power receiving device 100, the default mode of the power receiving device 100 is the PD mode.

In step S120, the detection unit 121A of the determination module 121 converts the pin signal Sᵢₙ into the conversion signal S_{O}. In the first embodiment, as illustrated in FIG. 3A, the pin signal Sᵢₙ of the CC pin 111 of the power supply device 200A has the first voltage V₁ (for example, 1.1 V), and the corresponding conversion signal S_{O} has the first conversion Voltage Vₜₕ₁ (for example, 0 V), as illustrated in FIG. 4A. In the second embodiment, as illustrated in FIG. 3B, the pin signal Sᵢₙ of the CC pin 111 of the power supply device 200B has the second voltage V₂ (for example, 1.6 V), and the corresponding conversion signal S_{O} has the second conversion Voltage Vₜₕ₂ (for example, 3.3 V), as illustrated in FIG. 4B. In the third embodiment, as illustrated in FIG. 3C, the pin signal Sᵢₙ of the CC pin 111 of the power supply device 200C is the BMC signal, and the corresponding conversion signal S_{O} has at least one waveform change region (for example, square wave), as illustrated in FIG. 4C.

In step S130, the signal generation unit 121B of the determination module 121 determines whether the power supply device 200 supports the PD mode according to the conversion signal S_{O}. If not, the process proceeds to step S140; if so, the process proceeds to step S150.

In step S140, based on the power supply device 200 not supporting the PD mode, the signal generation unit 121B generates the first switching signal SNPD. For example, neither the power supply device 200A (illustrated in FIG. 3A) of the first embodiment nor the power supply device 200B (illustrated in FIG. 3B) of the second embodiment supports the PD mode, and their conversion signal S_{O} does not appear the waveform change region, and accordingly the signal generation unit 121B generates the first switching signal SNPD, wherein the first switching signal SNPD is, for example, one of 0 and 1.

In step S145, the mode switching module 123 is disconnected from the PD controller 122 of the power receiving device 100 based on the first switching signal SNPD, as illustrated in FIG. 2. Alternatively, the mode switching module 123 switches from a connection state to be disconnected from the PD controller 122 of the power receiving device 100 according to the first switching signal SNPD.

In step S150, based on the power supply device 200 supporting the PD mode, the signal generation unit 121B generates the second switching signal SPD. For example, the power supply device 200C of the third embodiment supports the PD mode, and its conversion signal S_{O} has a waveform change region, and accordingly the signal generation unit 121B generates the second switching signal SPD, wherein the second switching signal SPD is, for example, the other of 0 and 1.

In step S155, based on the second switching signal SPD, the mode switching module 123 maintains the connection with the PD controller 122 of the power receiving device 100, as illustrated in FIG. 1. Alternatively, based on the second switching signal SPD, the mode switching module 123 switches from a disconnection state to the connection with the PD controller 122 of the power receiving device 100.

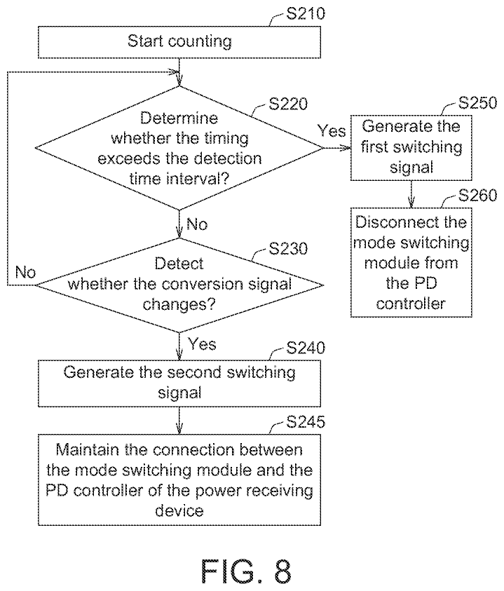

Referring to FIG. 8, FIG. 8 illustrates a flow chart of another mode switching method of the power receiving device 100 in FIG. 1.

In step S210, the timer 121B3 starts counting.

In step S220, the waveform detection unit 121B1 determines whether the timing exceeds the detection time interval. If not, the process proceeds to step S230; if so, the process proceeds to step S250.

In step S230, the determination module 121 detects whether the conversion signal S_{O} changes. If not, the process returns to step S220; if so, the process returns to step S240.

In step S240, within the detection time interval, the mode detector 121B2 generates the second switching signal SPD based on the change in the conversion signal S_{O}.

In step S245, based on the second switching signal SPD, the mode switching module 123 maintains the connection with the PD controller 122 of the power receiving device 100, as illustrated in FIG. 1. Alternatively, based on the second switching signal SPD, the mode switching module 123 switches from the disconnection state to the connection with the PD controller 122 of the power receiving device 100.

In step S250, when the detection time interval is exceeded, if the switching signal S_{O} does not change, the mode detector 121B2 accordingly generates the first switching signal SNPD.

In step S260, based on the first switching signal SNPD, the mode switching module 123 is disconnected from the PD controller 122 of the power receiving device 100, as illustrated in FIG. 2. Alternatively, based on the first switching signal SNPD, the mode switching module 123 switches from the connection state to be disconnected from the PD controller 122 of the power receiving device 100.

In summary, embodiments of the present invention provide a switching circuit, a power receiving device using the same and a mode switching method thereof, which may determine whether the power supply device supports the PD mode. If the power supply device does not support PD mode (the power supply device will not send out the BMC signal), the power receiving device may activate or switch to the non-PD mode (so that the power receiving device does not wait for the BMC signal from the power supply device), and accordingly it enables subsequent charging and/or data transmission between the power supply device and the power receiving device. If the power supply device supports PD mode, the power receiving device may activate or switch to PD mode so that the power supply device and the power receiving device may perform the PD protocol. After completing the PD protocol, the power supply device and the power receiving device may perform subsequent charging and/or data transmission.

While the invention has been described by way of example and in terms of the preferred embodiment(s), it is to be understood that the invention is not limited thereto. Based on the technical features embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. A switching circuit, disposed on a power receiving device and electrically connected to a Universal Serial Bus Type-C (USB Type-C) connector of the power receiving device, and comprising:
a determination module configured to:
determine whether a power supply device supports a power delivery (PD) mode according to a pin signal of a Configuration Channel (CC) pin of the USB Type-C connector; and
generate a first switching signal based on the power supply device not supporting the PD mode;
a PD controller electrically connected to the determination module; and
a mode switching module selectively electrically connected to the PD controller and configured to be disconnected from the PD controller according to the first switching signal.

2. The switching circuit according to claim 1, wherein the mode switching module is further configured to directly conduct with the PD controller based on a connection between the power supply device and the power receiving device.

3. The switching circuit according to claim 1, wherein the determination module comprises:
a detection unit configured to convert the pin signal into a conversion signal;
a signal generation unit configured to:
determine whether the power supply device supports the PD mode based on the conversion signal; and/or
generate the first switching signal based on the power supply device not supporting the PD mode, or generate a second switching signal based on the power supply device supporting the PD mode.

4. The switching circuit according to claim 3, wherein the signal generation unit comprises:
a waveform detection unit configured to detect whether there is a change in the conversion signal; and
a mode detector is configured to:
generate the second switching signal based on the change in the conversion signal; and
generate the first switching signal based on absence of the change in the conversion signal.

5. The switching circuit according to claim 4, wherein the waveform detection unit is further configured to detect whether there is the change in the conversion signal within a detection time interval.

6. The switching circuit according to claim 3, wherein the power supply device does not support the PD mode, and the power supply device comprises a CC pin;
wherein when there is no electrical signal transmission between the CC pin of the power supply device and the CC pin of the USB Type-C connector of the power receiving device, the conversion signal has a first conversion voltage; and
when there is the electrical signal transmission between the CC pin of the power supply device and the CC pin of the USB Type-C connector of the power receiving device; the conversion signal has a second conversion voltage;
wherein the first conversion voltage and the second conversion voltage are different.

7. A power receiving device, comprising:
a USB Type-C connector; and
a switching circuit electrically connected to the USB Type-C connector and comprising:
a determination module configured to:
determine whether a power supply device supports a PD mode based on a pin signal of a CC pin of the USB Type-C connector; and
generate a first switching signal based on the power supply device not supporting the PD mode;
a PD controller electrically connected to the determination module; and
a mode switching module selectively electrically connected to the PD controller and configured to be disconnected from the PD controller based on the first switching signal.

8. The power receiving device according to claim 7, wherein the mode switching module is further configured to:
directly connect the PD controller based on a connection between the power supply device and the power receiving device.

9. The power receiving device according to claim 7, wherein the determination module comprises:
a detection unit configured to:
convert the pin signal into a conversion signal;
a signal generation unit configured to:
determine whether the power supply device supports the PD mode according to the conversion signal; and/or
generate the first switching signal based on the power supply device not supporting the PD mode, or generate a second switching signal based on the power supply device supporting the PD mode.

10. The power receiving device according to claim 9, wherein the signal generation unit includes:
a waveform detection unit configured to:
detect whether there is a change in the conversion signal; and
a mode detector configured to:
generate the second switching signal based on the change in the conversion signal; and
generate the first switching signal based on absence of the change in the conversion signal.

11. The power receiving device according to claim 10, wherein the waveform detection unit is further configured to:
detect whether there is the change in the conversion signal within a detection time interval.

12. The power receiving device according to claim 9, wherein the power supply device does not support the PD mode; the power supply device comprises a CC pin;
wherein when there is no electrical signal transmission between the CC pin of the power supply device and the CC pin of the USB Type-C connector of the power receiving device, the conversion signal has a first conversion voltage; and
wherein when there is electrical signal transmission between the CC pin of the power supply device and the CC pin of the USB Type-C connector of the power receiving device, the conversion signal has a second conversion voltage;
wherein the first conversion voltage and the second conversion voltage are different.

13. A mode switching method, comprising:
determining whether a power supply device supports a PD mode according to a pin signal of a CC pin of a USB Type-C connector of a power receiving device by a determination module;
generating a first switching signal based on the power supply device not supporting the PD mode by the determination module; and
disconnecting a mode switching module from a PD controller of the power receiving device based on the first switching signal.

14. The mode switching method according to claim 13, further comprising:
directly conducting the mode switching module with the PD controller based on a connection between the power supply device and the power receiving device.

15. The mode switching method according to claim 13, further comprising:
converting the pin signal into a conversion signal by the determination module;
determining whether the power supply device supports the PD mode based on the conversion signal by the determination module; and/or
generating the first switching signal based on the power supply device not supporting the PD mode, or generating a second switching signal based on the power supply device supporting the PD mode by the determination module.

16. The mode switching method according to claim 15, further comprising:
detecting whether there is a change in the conversion signal by the determination module;
generating the second switching signal based on the change in the switching signal by a mode detector; and
generating the first switching signal based on absence of the change in the switching signal by the mode detector.

17. The mode switching method according to claim 16, further comprising:
detecting whether there is the change in the conversion signal within a detection time interval by the waveform detection unit.

18. The mode switching method according to claim 15, wherein when the power supply device does not support the PD mode, the power supply device comprising a CC pin; the mode switching method further comprises:
when there is no electrical signal transmission between the CC pin of the power supply device and the CC pin of the USB Type-C connector of the power receiving device, the conversion signal has a first conversion voltage; and
when there is the electrical signal transmission between the CC pin of the power supply device and the CC pin of the USB Type-C connector of the power receiving device, the conversion signal has a second conversion voltage;
wherein the first conversion voltage and the second conversion voltage are different.
